(19) United States
(12) Patent Application Publication
(10) Pub. No.: US 2006/0242843 A1
(43) Pub. Date: Nov. 2, 2006

(54) Telescoping V blade cutting apparatus

(76) Inventor: Fred Schoenberg, Neptune City, NJ (US)

Correspondence Address: DENNIS L. COOK, ESQ.;THE LAW OFFICES OF DENNIS L COOK PLLC, 12718 DUPONT CIRCLE, TAMPA, FL, 33626, US

(21) Appl. No.: 11/412,551

(22) Filed: Apr. 27, 2006

Related U.S. Application Data
(60) Provisional application No. 60/675,424, filed on Apr. 27, 2005.

(51) Int. Cl. B26B 3/00

(52) U.S. Cl. 30/314

(57) ABSTRACT

The present invention relates to an improved cutting apparatus comprising a sharpened V blade, a catch to capture and remove cut materials, a section of serrated or saw toothed edge, and interchangeable telescoping handle wherein the V design of said blade increases the effectiveness of cutting action with regard to thin flexible generally cylindrical materials such as ropes or lines.

### CROSS-REFERENCE TO RELATED APPLICTION

The present application claims the benefit of previously filed co-pending Provisional Patent Application, Ser. No. 60/675,424, filed Apr. 27, 2005, and incorporates by reference the contents therein.

### FIELD OF INVENTION

This invention relates, generally, to a V shaped cutting apparatus with a serrated or saw toothed edge attached to a telescoping handle for use in various applications including, but not limited to, boating, gardening, or the evisceration or skinning of animals. The straight V design cutting head provides an innovative geometric design that reduces the amount of force required to cut or cleave through various materials while the telescoping handle affords the user flexibility in application.

### BACKGROUND OF THE INVENTION

The design and application for the common knife has evolved quickly in light of mankind no longer depending upon the tool for protection. One of the first innovations was the now traditional “hook” knife. This type of knife has been around for many years and uses include, typically, gutting animals and fish and there are some used for emergency parachute cord and seatbelt releases. There also exists a type of new style letter opener that has often been used as a promotional item.

In order to understand the novel and unobvious innovation to the design of this apparatus, an examination of the prior art is necessary. There is a huge difference in the cutting dynamics between these uses. The act of hunting, killing and eviscerating an animal, opening a letter, or the emergency cutting of the seatbelt or parachute cord uses differ in practice substantially, in that the former is typically a thin material being cut as compared to the cord.

U.S. Design Pat. No. 409,270 by Balolia discloses an ornamental design for a game blade that is a short, hand held device with a short handle ending in a curved blade. There exists a series of serrated grooves on the same side of the blade as the curve. The hook blade has a semicircular shape with the out portion of the semicircular blade as shown being less than half the length of the inner surface of the blade. This game blade does not contain a telescoping handle nor does it possess the innovative feature of an actual V blade.

U.S. Pat. No. 6,658,743 by Dudley, Jr. et al. discloses a skinning combination game knife having a handle and a blade portion having a tip, a top back edge and a bottom front edge and a rear portion opposite the tip, the blade portion having up to five cutting surfaces. A unique feature is a small gut hook positioned below the forefinger aperture in the rear of the blade portion and above the handle and opening toward the user. Other cutting surfaces are the back cutting edge, a top back large gut hook, a front bottom cutting edge, a front serrated edge to the rear of the front cutting edge, and a bottom edge small gut hook to the rear of the serrated edge and in the vicinity of the handle. A forefinger aperture is spaced toward the back edge from the small gut hook near the handle. Dudley points out the innovation of the gut hooks located on the back and top of the blade. These gut hooks have a semicircular appearance and may be used to cut or tear through skin or other materials. These hooks are not similar to the innovative hook knife disclosed herein.

U.S. Design Pat. No. 153,776 by H. J. Einnerman discloses the ornamental design for a salvage hook with a hook like design containing a series of serrated teeth within the grove of said hook. The outer portion of the hook is a knife blade and terminates into sharp points on both ends of the hook. Whereas this design is somewhat angular in nature, it is not the V hook as disclosed herein.

U.S. Pat. No. 3,241,236 by James P. Capps discloses a game knife that is specifically suited for use in skinning and preparing animal flesh or hides. The innovation of Capps is an elongated blade with a sharp bottom end and serrated portion. Said blade terminates into a semicircular hook with a backward facing point and dull inner face. The application is to insert the hook of the blade into an opening between the hide or skin of an animal and then to pull the hook forward thereby eviscerating the hide from the carcass. The object of this invention significantly differs from that of this invention.

U.S. Pat. No. 2,007,700 by Theodore Ziminski discloses a pruning hook that is essentially an arcuate blade made from a thin gauge of metal that is attached to a groove in a handle and riveted therein. The arcuate blade geometry is meant to prune smaller bushes and shrubbery such as currants, gooseberries, raspberries, or the like. The blade does not contain any serration nor specific geometry by which to maximize force as applied to the item to be cut or cleaved.

U.S. Pat. No. 866,308 by Irville Sanders discloses a cutting implement comprising a stem having a hook at one end and having a depression in one side of the hook to form a seat and having opposite edges of the seat under-cut, a cutter having opposite edges beveled to engage under the overhanging portions of the under-cut edges of the aforementioned seat in which said cutter is fitted and means for securing the cutter to the hook. This grape-cutter was an innovative design for the time, circa 1907, and afforded the user to quickly cut fruit from a vine without damage to the vine itself. This invention of this application is substantially different from this and all other mentioned prior art in that the V design improves all previously produced apparatus. None of these previously discussed apparatus' are as advanced nor as efficient as the object of this invention.

The act of cutting a branch, vine, length of rope, or other item is an activity common to boaters, homeowner, farm hands, gardeners, landscapers, etc. Throughout history, the knife has been used to accomplish this task. Initially, the knife served many functions including hunting, protection, skinning and shearing of animals, and numerous other tasks. However, the basic form of the knife was manufactured for protection and hunting. Therefore, it was difficult to apply the knife to other specialized tasks. For instance, the same knife used for killing wild game was then employed to eviscerate said game. A steady stream of design innovations over the past 100 years as has been documented and supplied herein in the prior art illustrates these innovations as the knife has become specialized for specific functions removed from hunting and protection. Key innovations have centered around the “hook” design.

The conceptual difference can be realized by thinking of how an ax cuts versus how a conventional knife blade cuts. For instance, if one were to cut a rope with an ax, he would chop or hack the rope. The sharp edge of the ax would come crashing down on the rope in a direction perpendicular to the axis of the rope. The tremendous force of the sharp edge of the ax would actually crush, break and tear the fibers of the rope. On the other hand, if one were to cut that same rope with a conventional knife edge, the sharp edge of the blade would again be applied to the rope in a perpendicular direction to the axis of the rope with some pressure (force) in the downward direction, and it would then be slid longitudinally in a direction 90 degrees (but within the same plane) to the downward force, increasing the downward force gradually. The combination of the sliding action and the downward force 90 degrees away from the sliding action now is the cause of the cutting of the rope. Instead of the fibers being crushed and broken by brute force they are instead eased apart in a much less violent action. When cutting thin materials with a sharpened curved hook such as those in a gutting knife, the cutting action is similar to the cutting action of a conventional knife because the geometry of the curved knife edge and the flat surface being cut, are akin to a downward force and sliding action combined so long as the plane of the thin material does not approximate the radius of the curved knife edge. However, the geometry of the curved hook, when used in cutting the parachute cord, is much more like the ax and the rope, Because the cord is forced to a position that approximates the direction of the radius of the curved knife a much greater (direct) force is required to cut the cord.

The law of conservation of energy tells us that the same amount of energy is required to cut the rope, regardless of the method. What the law does not tell us is the excess energy required when an inefficient method is used. An analogy would to be to consider two equal horsepower engines; one properly tuned and one not. They both develop the same power but the improperly tuned one uses more fuel that the other. And so it is with the cutting of the rope, the slicing of the rope is more energy efficient than the chopping of the rope.

The basis of this invention is a cutting apparatus with V blade. This apparatus converts the ax like cutting of thick materials to the geometry of the cutting of thin materials. The dynamics of cutting are automatically forced into a sliding action and a perpendicular force being applied simultaneously to the material being cut. This innovative and new design greatly decreases the amount of total force required to cut through materials such as vines, ropes, branches, or similar cylindrical shaped materials.

It is therefore an object of this invention to provide an improved apparatus with a blade that is in the design of a V to facilitate ease of cutting with less force distributed by the operator.

It is another object of this invention to provide the V blade with a catch device to grasp and remove the cut debris and also have it attached to a telescoping handle to provide for a dynamic and functional cutting reach of the apparatus.

It is another object of this invention to provide for a serrated or saw toothed edge on the opposite side of the V blade to facilitate sawing if required.

It is yet another object of this invention to provide said apparatus wherein said apparatus is modified with mechanical stops, one of which may be the catch device, to prevent the serrated saw from coming detached from the cutting surface.

It is yet another object of the invention to provide said apparatus with an inverted sharpened point (a V) at apex of the V Blade device.

Its is yet another object of the invention to provide an apparatus with a sharpened anterior face to the blade.

This and other objects of the invention will in part be obvious and will in part appear hereinafter.

### BRIEF DESCRIPTION OF THE FIGURES

The invention will now be described, by way of example only, with reference to the accompanying figures in which:

FIG. 1 is an environment side view of the entire apparatus;

FIG. 2 is a side view of the two components of the invention as disassembled;

FIG. 3 is a longitudinal view looking at the TOP surface of the apparatus;

FIG. 4 is a longitudinal view looking at the BOTTOM surface of the apparatus;

FIG. 5 is a blown up side view of the V Blade; and

FIG. 6 is a blown up side view of an alternate embodiment V Blade.

Items of the figures:
1. Handle
2. Grip
3. Overall V Blade
4. Locking Button
5. Internal Apex of V
6. External Apex Point of V
7. Terminal Point
8. Serrated Edge
9. Reduced Interior Apex
10. Bifurcated External Apex
11. Stop Knob and Catch Device
12. Extended Saw Tooth Edge
13. Body of insertion tube

### SUMMARY OF THE INVENTION

This invention relates to a telescoping cutting apparatus that has at its primary design a V blade thereby maximizing the force to work ratio of action. The V shape of the apparatus possesses sharpened edges both within the V and external to it. The shape results with an external apex and that is in the fashion of a point and an internal apex that that acts as static pair of blades or a scissors. Near the handle on the external face of the V is a catch device to grasp and remove the cut debris and there is a serrated or saw toothed section comprised of small “teeth” to allow for a sawing action if so required. The entire apparatus is attached to a telescoping handle that terminates into a rubberized or plastic grip.

The V design provides for an improved method to cut rope, line, branches, vines, or any other cylindrical or linear piece of material in a much more rapid and energy conserving fashion. The conceptual difference can be realized by thinking of how an ax cuts versus how a conventional knife blade cuts. For instance, if one were to cut a rope with an ax, he would chop or hack the rope. The sharp edge of the ax would come crashing down on the rope in a direction perpendicular to the axis of the rope. The tremendous force of the sharp edge of the ax would actually crush, break and tear the fibers of the rope. On the other hand if one were to cut that same rope with a conventional knife edge, the sharp edge of the blade would again be applied to the rope in a perpendicular direction to the axis of the rope with some pressure (force) in the downward direction and it would then be slid longitudinally in a direction 90 degrees (but within the same plane) to the downward force thereby increasing the downward force gradually. The combination of the sliding action and the downward force 90 degrees away from the sliding action now is the cause of the cutting of the rope. Instead of the fibers being crushed and broken by brute force they are instead eased apart in a much less violent action. When cutting thin materials with a curved hook such as those in a gutting knife, the cutting action is similar to the cutting action of a conventional knife because the geometry of the curved knife edge and the flat surface being cut, are akin to a downward force and sliding action combined. The geometry of the curved hook when used in cutting the parachute cord, however is much more like the ax and the rope. A much greater (direct) force is required to cut the cord.

The law of conservation of energy tells us that the same amount of energy is required to cut the rope, regardless of the method. What the law does not tell us is the excess energy required when an inefficient method is used. An analogy would to be to consider two equal horsepower engines; one properly tuned and one not. They both develop the same power but one used more fuel that the other. Therefore, the slicing of the rope is more energy efficient than the chopping of the rope.

The apparatus of this invention is a cutting apparatus with “V” blade. This apparatus converts the ax like cutting of thick materials to the geometry of the cutting of thin materials. The dynamics of cutting are automatically forced into a sliding action and a perpendicular force applied simultaneously to the material being cut. This innovative and new design greatly decreases the amount of total force required to cut through materials such as vines, ropes, branches, or similar materials.

In an alterative embodiment, the V Blade is modified to facilitate for an improved garden cutting tool. The V Blade is bifurcated at the external apex point providing for two points and has another V blade design facing outward from the apparatus. This design modification allows for a cutting action when the apparatus is moved forward against a twig, branch, or root. In addition to the bifurcation, the serrated or saw toothed edge is extended and designed in an arcuated fashion and has extended stop knobs that prevent the “saw” from becoming dislodged from the branch, board, or other item being cut and one of the stops acts as the catch device to grasp the cut debris. The main or overall V blade is somewhat smaller in this embodiment and the handle is substantially longer.

The largest diameter for twig/branch cutting with the alternate apparatus is about ½ inch diameter. Larger diameters than that become an issue for the apparatus because of technical issues of space as to where the cut material has to go and because branches and typical agricultural materials to be cut are not very flexible. The arcuated serrated section of the apparatus is implemented for items whose diameter is larger than approximately ½ inch. Mechanical stops are provided at each end of the serrated or saw toothed edge to limit the reciprocating distance of the apparatus while cutting and to act to keep the serrated or saw toothed edge in contact with the item being cut. One of the mechanical stops can also be used as a catch device to remove the cut debris.

### DESCRIPTION OF THE PREFERRED EMBODIMENT

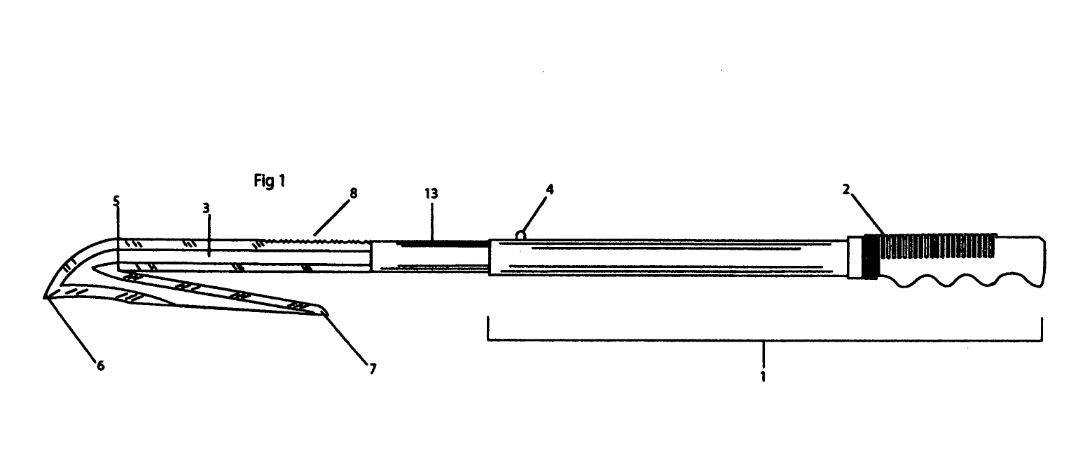

The present invention as shown in FIG. 1, shows from right to left, grip (2) made of a material accepted for the applications as attached to the hollow tube handle (1) itself. Within the handle (1) is a hole to allow for the locking button (4) to clear through the handle (1) thereby locking in the desired length of the over apparatus. The V Blade (3) component of the apparatus, containing the locking button (4) therefore inserts into the handle (1). The V Blade (3) is attached to another piece of tube, the insertion tube (13), containing the locking button (4). The insertion tube (13) has a diameter lightly smaller than the inner diameter of the handle (1) tube in order accommodate insertion into said handle (1). The V Blade begins (3) with a section of serrated edge (8). The V Blade (3) is sharpened on both the top and bottom and continues longitudinally until the blade sweeps downward and reaches a point or apex called the external apex (6) as it is the external apex of the V design. The blade then folds back down along itself longitudinally toward the handle ultimately reaching the terminal point (7) of the blade. Once again, the blade folds back toward the external apex (6) until it reaches the internal apex (5). The blade then folds again in a V shape and runs longitudinally back toward the handle once again until the sharpened section of the V Blade (3) terminates back into the body of the insertion tube (13).

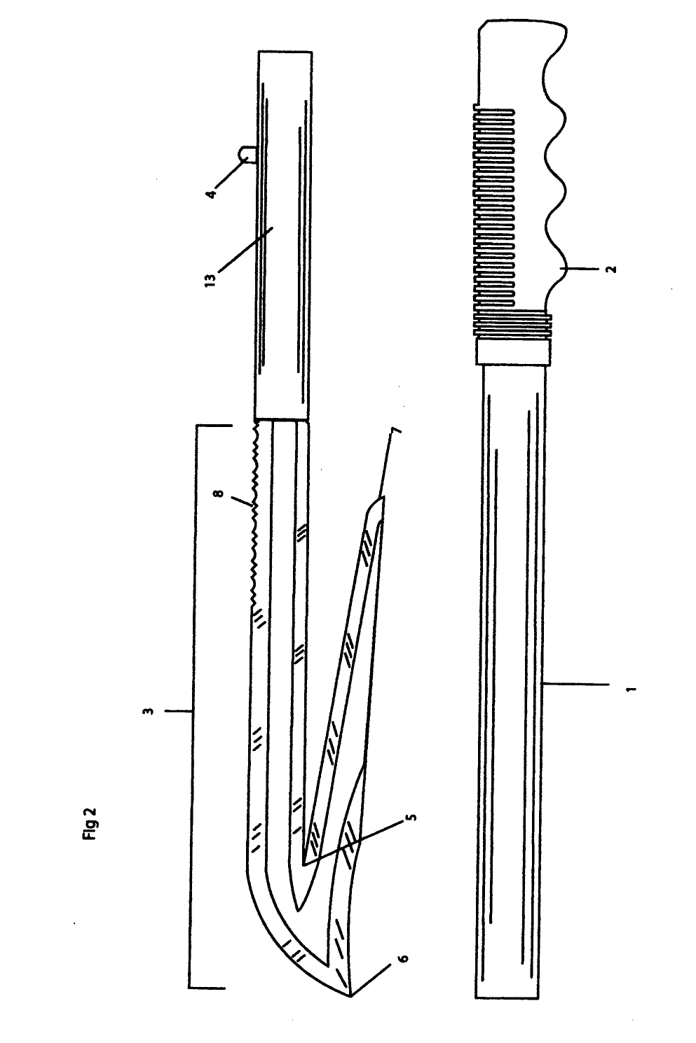

FIG. 2 illustrates the two main components of the apparatus presented as dissembled. The molded grip (2) is attached to the handle (1) tube. Not shown is the hole that is located in the handle (1) for accepting the locking button (4). The body of the insertion tube (13) contains the locking button (4) that is a spring loaded button common to the art. The use of the locking button facilitates flexibility in the length and other characteristics of the handle (1) meaning that various lengths and or designs of handle (1) may be used providing that the body of the insertion tube (13) and the locking button (4) are compatible. Some distance distal from the locking button (4), the sharpened V Blade (3) begins with an area of many “teeth” or the serrated edge (8). This edge runs some distance and then becomes the simple sharpened edge of the V Blade (3) component. The sharpened edge runs a distance until bending into a sharp point located at the external apex point (6). The sharpened edge then runs back, longitudinally towards the handle (1) until reaching another point, the terminal point (7). From this point, the sharpened edge then folds back toward the external apex point (6) until reaching the internal apex (5). The internal apex is the primary innovation to the invention being that the small V angle of the sharpened edges provides for a very smooth and easy cut of fabrics, cotton, nylon, polypropylene or any other rope or fiber type material common to ropes or lines along with vines, roots, or small branches. Upon reaching this internal apex point (5), the sharpened edge then folds back toward the handle (1) until terminating at the body of the insertion tube (13).

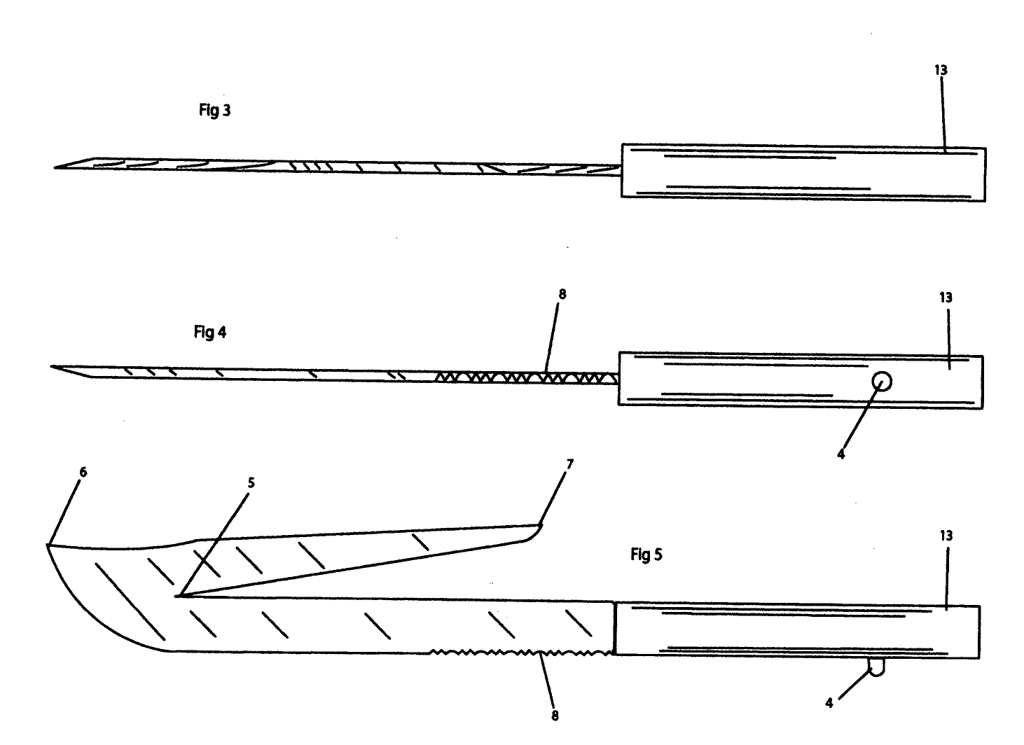

FIG. 3 shows a view of the V Blade apparatus as looking towards the terminal point (7) perpendicular to the plane of the paper. Note the body of the insertion tube (13) to the right of prior to the V Blade (3). FIG. 4 shows the V Blade apparatus as looking towards the serrated edge (8). The locking button (4) is located on the body of the insertion tube (13).

FIG. 5 is a blow up side view of the V Blade further illustrating the serrated edge (8), the external apex (6), the terminal point (7), and internal apex (5).

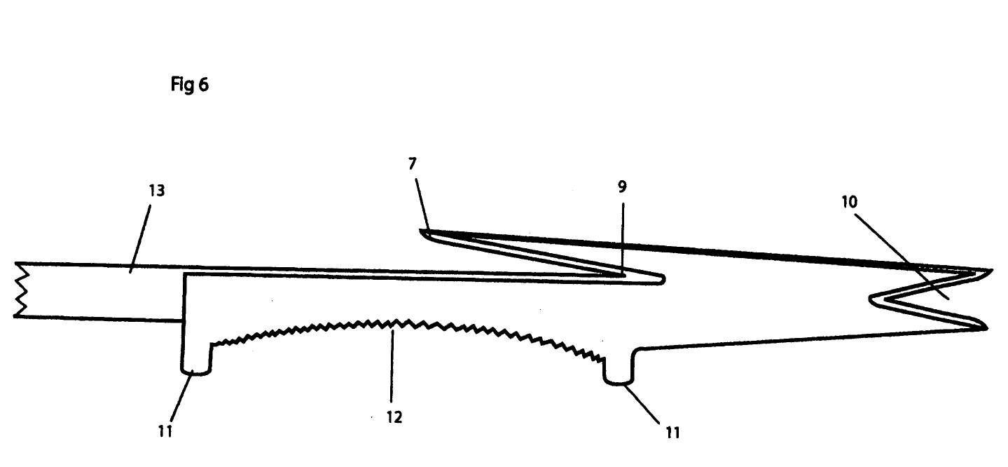

FIG. 6 is a side view illustration of the alternate embodiment of the V Blade cutting apparatus as modified for gardening or agriculture type activities. The apparatus is meant to telescope in the same fashion using a locking butting located on an insertion tube body (13) that slips into a tube handle wherein said locking button is able to spring load through the handle. The V Blade apparatus of the alternate embodiment is comprised of a much larger serrated edge section, or extended serrated edge (12) that is flanked by two mechanical stops or knobs (11) that limit the reciprocation action of the serrated edge (12) and act to keep the tool on the item being cut. The back mechanical stop (12) is situated such that it is also used as a catch device to remove the debris once it is cut The external apex of the preferred embodiment is bifurcated in this embodiment forming a bifurcated external apex (10) in order to facilitate a lunging or forward movement cutting action. This bifurcated external apex (10) is in itself another V Blade and works in the same fashion as the reduced internal apex (9) of the apparatus. The reduced internal apex (9) is approximately 65% of the actual size of the internal apex (6) of the preferred embodiment. The terminal point (7) is the same as in the preferred embodiment.

Although this invention has been described in the form of a preferred embodiment, many modifications, additions, and deletions, may be made thereto without departure from the spirit and scope of the invention, a set forth in the following claims.

What is claimed is:

1. A cutting apparatus comprised of:
a V Blade with two opposing legs meeting at an internal apex with said opposing legs sharpened on the internal face of each of said opposing legs extending from said internal apex for use in cutting with a pulling motion;
a handle attached to either of said opposing legs at said opposing legs distal end from said internal apex; and,
a catch attached close to said distal end of said opposing leg which has said handle attached wherein said catch is extending away from said sharpened V Blade and is of sufficient size and shape to contact and hold material that was cut.

2. The apparatus of claim 1 wherein the design of the V Blade is sharpened on both the external and internal faces of the V Blade.

3. The apparatus of claim 1 further comprising an external apex on the external face of said V Blade wherein said external apex of said V Blade is sharpened to a point

4. The apparatus of claim 1 wherein the design of the sharpened internal face of the V blade facilitates ease of cutting rope or similar materials via the combination of shear and compression when the apparatus is pulled around the rope or similar material.

5. The apparatus of claim 1 one of said opposing legs has a serrated edge on the external face of said V Blade wherein said serrated edge is comprised of individual teeth in order to accommodate a sawing action.

6. The apparatus of claim 1 wherein said serrated edge is flanked a mechanical stop and said catch thereby limiting the reciprocating action of the apparatus when implemented for sawing.

7. The apparatus of claim 1 wherein said handle is capable of attaching to an extension pole.

8. An apparatus comprised of:
a V Blade with two opposing legs meeting at an internal apex with said opposing legs sharpened on the internal face of each of said opposing legs extending from said internal apex for cutting in a pulling motion;
a handle attached to either of said opposing legs at the distal end of said opposing leg from said internal apex; and,
a catch attached close to said distal end of said opposing leg which has said handle attached wherein said catch is extending away from said sharpened V Blade.
said V Blade having a bifurcated external apex for cutting in a pushing motion.

9. The apparatus of claim 8 wherein one of said opposing legs has a serrated edge opposite said sharpened edge wherein the serrated edge is comprised of individual teeth in order to accommodate a sawing action and wherein said internal apex is smaller than said serrated section.

10. The apparatus of claim 8 wherein said serrated edge is flanked with a mechanical stop and said catch thereby limiting the reciprocating action of the apparatus when implemented for sawing.

11. The apparatus of claim 8 wherein said bifurcated external apex contains a V inner shape.

12. The apparatus of claim 11 wherein said bifurcated external apex is used to cut materials in a forward pushing action or movement.

13. An apparatus for cutting rope, line, or vine of any natural or synthetic material using a V blade cutting tool and a catch to grasp the material once it has been cut.

14. The apparatus of claim 13 wherein said V blade is sharpened on both internal and external faces in order to cut rope or line of any natural or synthetic material of manufacture by grasping or grabbing the rope or line and pulling the apparatus upwards in order to drive the rope or line toward the internal apex of the apparatus.

15. An apparatus comprising a V Blade design and a catch to cut through any flexible or non flexible material by using said V Blade design to combine the forces of shearing and cleaving and using said catch to grasp and remove the material once it has been cut.

16. The apparatus of claim 15 further comprising a section of the blade comprised of a serrated edge for sawing.

17. The apparatus of claim 16 wherein said serrated edge is flanked by a mechanical stop and said catch thereby limiting the reciprocating action of the apparatus when implemented for sawing.

18. The apparatus of claim 15 wherein said V Blade and said catch is attached to a telescoping pole.
